(19) United States
(12) Patent Application Publication
(10) Pub. No.: US 2016/0253626 A1
(43) Pub. Date: Sep. 1, 2016

(54) Network Interview System and Interview Method Thereof

(71) Applicant: Chung-Nan Tien, Taipei City (TW)

(72) Inventor: Chung-Nan Tien, Taipei City (TW)

(21) Appl. No.: 14/973,681

(22) Filed: Dec. 17, 2015

(30) Foreign Application Priority Data
Feb. 26, 2015 (TW) 104106273

(51) Int. Cl. G06Q 10/10; G09B 7/02; G06Q 50/00; H04L 29/06

(52) U.S. Cl. CPC G06Q 10/1053; H04L 63/08; G09B 7/02; G06Q 50/01

(57) ABSTRACT

A method of performing a network interview includes a questioner providing a question set with respect to a designated interviewee or a designated event. The questioner uploads the question set to a network in order to collect the support from a plurality of network users. When the question set receives the support of over a predetermined number of network users, the status of the question set becomes one which can be used in an interview. Afterwards at least one qualified interviewer would be given the right to conduct an interview. The at least one interviewer asks the designated interviewee or covers the designated event by a plurality of questions listed in the question set . The at least one interviewer uploads the responses of the interview to the network. The questioner receives the responses from the network.

### BACKGROUND OF THE INVENTION

1. Field of the Invention

The present invention illustrates a network interview system and interview method, and more particularly, the network interview with respect to a question set provided from network users.

2. Description of the Prior Art

With the generalization of the Internet, various information and data can be rapidly transmitted to network users. For example, Internet news and Internet television provide an immediate service that network users can acquire up-to-date information at any time instead of TV schedule being shown at a specific time interval. Nowadays, the Internet facilitates rapid and real-time information transmission. The Internet integration with social networks establishes an information sharing service. Some network users having expertise or skill in particular subject can share their knowledge and experience with other network users through the Internet. In other words, each network user would be regarded as a knowledge provider or knowledge recipient. By sharing information with other person, new knowledge or creativity will be gradually developed.

Since the network provides a convenient method for exchanging knowledge and information sharing service, the network has been already applied to various interview systems. Ina general interview system, the interviewer collects attitude information and opinions of interviewee by a conversation or discussion, such as using a telephone interview. The interview questions are designed in forms of three categories, including interview with structured-based questions, unstructured-based questions, and semi-structured-based questions. Specifically, when the interview uses unstructured-based questions, no pre-determined question is asked from the interviewer. The argument or subject of interview may be changed since the interviewer has some accidental or unexpected ideas. Thus, since the interview data is difficult to analyze, results of the interview using unstructured-based questions is of less interest in practice among these three categories of interview questions. When the interview uses structured-based or semi-structured based questions, all questions are pre-determined by the interviewer. In other words, the interviewer asks the pre-determined questions to the interviewee. Specifically, the interview data of the interview using structured-based or semi-structured based questions can be easy to record and analyze so that these two interview methods become two standardized interview methods in practice.

However, in a conventional network interview method by using structured-based or semi-structured based questions, the interview questions are generated from a large question set. The network users elect the appropriate questions as the interview questions from the large question set. The mechanism for electing interview questions depend on at least one popularity value, such as number of like clicks or number of dislike clicks. Thus, some network users or opponents may use certain unexpected methods to obstruct the interview questions to be published. Besides, the interview questions generated by election in a conventional network interview may be irrelevant or have low correlations. When the interview asks the interview questions generated by election to the interviewee, in-depth interview is difficult to achieve.

Thus, it is important to develop a network interview method which satisfies the following issues. First, the network interview method can choose appropriate interview questions. Second, the network interview method is designed to avoid some opponents obstructing the interview questions to be published. Third, the interviewer can conduct an in-depth interview.

### SUMMARY OF THE INVENTION

In an embodiment of the present invention, a method of performing a network interview is disclosed. The method includes a questioner providing a question set associating to at least one designated interviewee and/or at least one designated event, the questioner publishing the question set to a network in order to collect the support from a plurality of network users, when the question set receives the support from over a predetermined number of network users, changing a status of the question set to one which can be used in an interview, giving at least one qualified interviewer the right to conduct the interview, the at least one interviewer asking the at least one designated interviewee or covering the at least one designated event according to a plurality of questions listed in the question set, the at least one interviewer transmitting a response data of the interview to the network, and the questioner receiving the response data of the interview from the network.

In another embodiment of the present invention, a network interview system is disclosed. The system includes a questioner interface for transmitting a question set associating to at least one designated interviewee and/or at least one designated event provided from a questioner, an interviewer interface for transmitting data of at least one interviewer, a database for saving data, and a network server connected to the questioner interface and the interviewer interface, wherein the questioner provides the question set to the network server through the questioner interface, the network server saves the question set to the database and publishes the question set to a network in order to collect the support from a plurality of network users, when the question set receives the support from over a predetermined number of network users, the network server changes the status of the question set to one which can be used in an interview, at least one qualified interviewer is given the right to conduct the interview, the at least one interviewer asks the at least one designated interviewee or covering the at least one designated event according to a plurality of questions listed in the question set, the at least one interviewer transmits a response data of the interview to the network server, the network server saves the response data of the interview to the database, and the network server transmits the response data of the interview to the questioner through the questioner interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a network interview system according to an embodiment of the present invention.

FIG. 2 illustrates the flow chart of network interview method in FIG. 1 according to an embodiment of the present invention.

FIG. 3 illustrates the flowchart of at least one network user desired to be at least one interviewer in FIG. 1 according to an embodiment of the present invention.

FIG. 4 illustrates the flow chart of a grading evaluation process in FIG. 1 according to an embodiment of the present invention.

FIG. 5 is a block diagram of another network interview system according to an embodiment of the present invention.

FIG. 6 illustrates the flow chart of profit allocation in FIG. 5 according to an embodiment of the present invention.

FIG. 7 illustrates the flow chart of another network interview method according to an embodiment of the present invention.

FIG. 8 illustrates the flow chart of a method for improving the reliability of the interview according to an embodiment of the present invention.

FIG. 9 illustrates the flow chart of another method for improving the reliability of the interview according to an embodiment of the present invention.

### DETAILED DESCRIPTION

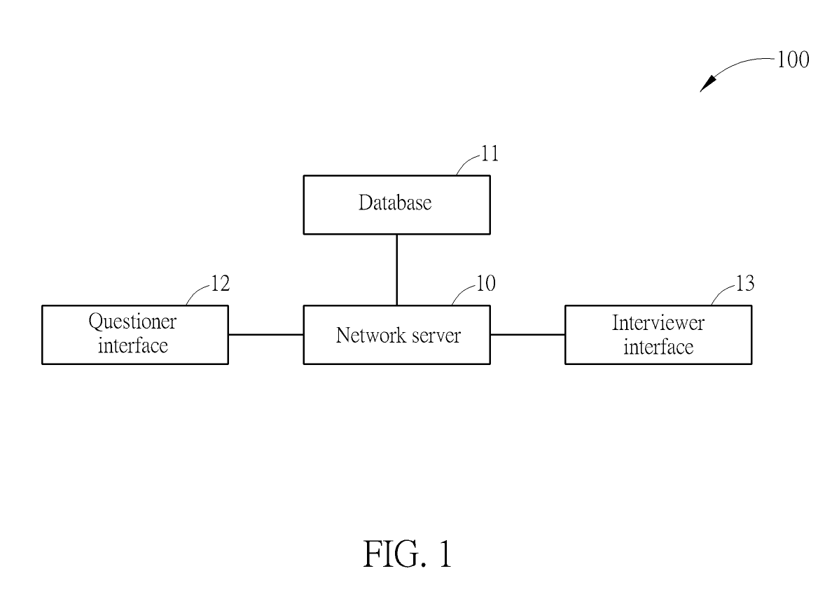

FIG. 1 is a block diagram of a network interview system 100 according to an embodiment of the present invention. As shown in FIG. 1, the network interview system 100 includes a questioner interface 12, an interviewer interface 13, a database 11, and a network server 10. The questioner interface 12 is used for receiving a question set provided from a questioner. The interviewer interface 13 is used for transmitting the question set to the interviewer and receiving response data of the interview from the interviewer. The database 11 is used for saving data. The network server 10 is connected to questioner interface 12, the interviewer interface 13, and the database 11. In the embodiment, the questioner interface 12 and the interviewer interface 13 can be two interfaces respectively disposed to two different computers. The database 11 includes data of all members of the network interview system 100, data of network news, data of interviewers, and data of questioners. The network server 10 can be connected to an open-access network, such as cloud networking server, blade server, or network station. The method for operating the network interview system 100 is detailed as follows.

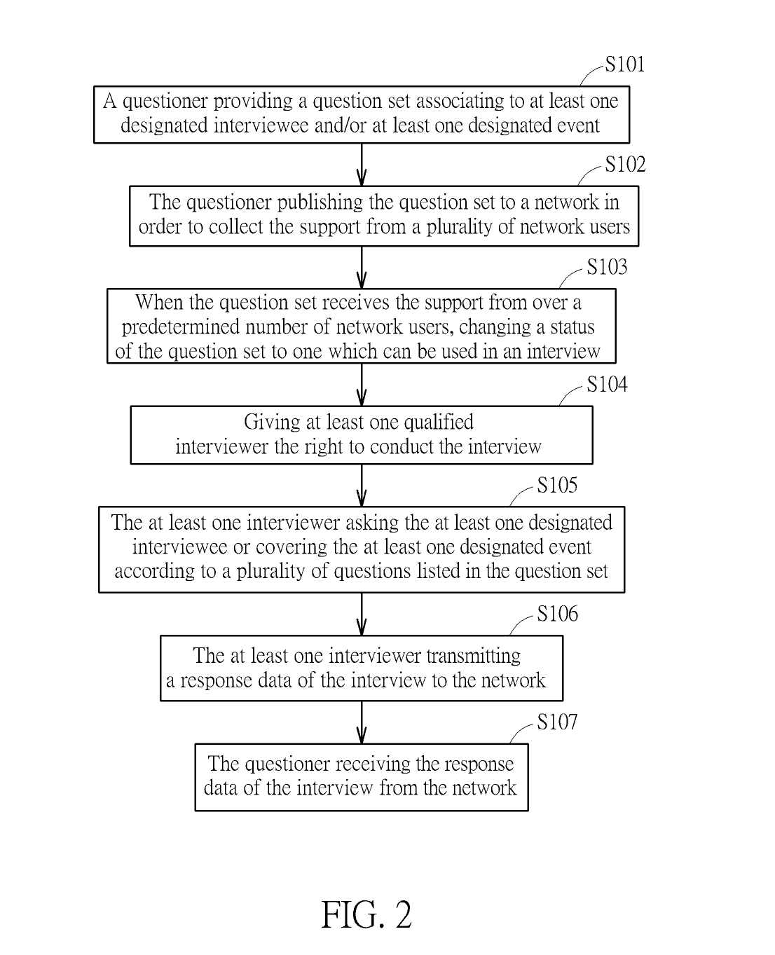

FIG. 2 illustrates the flow chart of the network interview method in FIG. 1 according to an embodiment of the present invention. As shown in FIG. 2, the network interview method includes 7 steps, as step S101 to step S107, as
step S101: a questioner providing a question set associating to at least one designated interviewee and/or at least one designated event;
step S102: the questioner publishing the question set to a network in order to collect the support from a plurality of network users;
step S103: when the question set receives the support from over a predetermined number of network users, changing a status of the question set to one which can be used in an interview;
step S104: giving at least one qualified interviewer the right to conduct the interview;
step S105: the at least one interviewer asking the at least one designated interviewee or covering the at least one designated event according to a plurality of questions listed in the question set;
step S106: the at least one interviewer transmitting a response data of the interview to the network; and
step S107: the questioner receiving the response data of the interview from the network.

For presentation simplicity, an example is introduced for illustrating the method of network interview through step S101 to S107. It is assumed that the network users receive the data of the interview from network news. Specifically, the data of the interview includes data of the interviewer (i.e., for example, a reporter) and data of the interviewee. However, the network users think that the questions that the interviewer is asking to the interviewee are irrelevant to the questions they desire to ask. Thus, the network users want to publish the new questions they desire to ask by using network in order to re-ask to interviewee. By doing so, network users have to become a member of network interview system 100. The network interview system 100 saves the data of all members to the database 11. The method for becoming the member of network interview system 100 can use the login process in a social network account. For example, a user can join using their membership of Facebook or Renren social networks. Users without a social network account can provide additional personal data for becoming the member of network interview system 100. In step S101, the questioner integrates the appropriate question set to be published. In step S102, the questioner publishes the question set to the network in order to collect the support from network users. When network server 10 receives the question set provided by the questioner, the question set is saved to the questioner data cluster of the database 11. In addition, the network server 10 provides the rights of modification for adjusting the description and the quantity of questions by the member. In the embodiment, the questions of the question set provided by the questioner associates to at least one designated interviewee. For example, the questioner wants to publish the questions associating public security. The questioner can designate a professional researcher or a professor to respond to the questions. By doing so, the interviewed result is objective and professional. The questions of the question set can associate with at least one designated event. For example, the questioner wants to get the information of travel sites, or the information of a commodity price in some specific countries. After the question set is published to the network by the questioner, the questioner can find the people to support the question set from the friends of social network, the friends of blog, or the friends of chat room. In the embodiment, the rate of support can be any positive popularity, such as number of “likes” in Facebook, YouTube, or Twitter. When the question set receives the support from over a predetermined number of network users (i.e., for example, over 1000 supports), the network server 10 changes a status of question set to one which can be used in an interview in step S103. When the status of question set is changed to one which can be used in an interview, the network server 10 gives at least one qualified interviewer the right to conduct the interview through the interviewer interface 13. The method of how to be the interviewer and how to decide a qualified interviewer are illustrated later. After at least one qualified interviewer has the right to conduct the interview, in step S105, the at least one interviewer asks the at least one designated interviewee or covering the at least one designated event according to a plurality of questions listed in the question set. In step S106, the at least one interviewer transmits the response data of the interview to the network. Specifically, the response data of the interview may include an audio recording file, a video file, interviewed images, and the response file of interviewee. After the network server 10 receives the response data of the interview, the response data of the interview is saved to the database 11. Then, the network server 10 transmits back the response data of the interview to the questioner through the questioner interface 12. In the embodiment, to ensure the response data of the interview is valid and authentic, the network interview system 100 can verify a correction and validity of interviewer identity by sending a short message to the smart phone. If the network interview system 100 successfully identifies and verifies the interviewer, the network interview system 100 allows that the response data of the interview can be transmitted back to the network. In addition, in step S106, if the response data of the interview is modified by the interviewer, all modifications are saved by the network interview system 100. By doing so, the objectivity of the interview can be improved.

Further, when the questioner provides the question set, the questioner can select several preferred interviewers from the list of interviewers in the database. Then, the questioner sends an invitation for an interview to the preferred interviewers so that the question set can be transmitted to the appropriate interviewers immediately. By doing so, the process of interview can be progressed smoothly.

In the following, the method of how to be an interviewer and how to decide a qualified interviewer are illustrated.

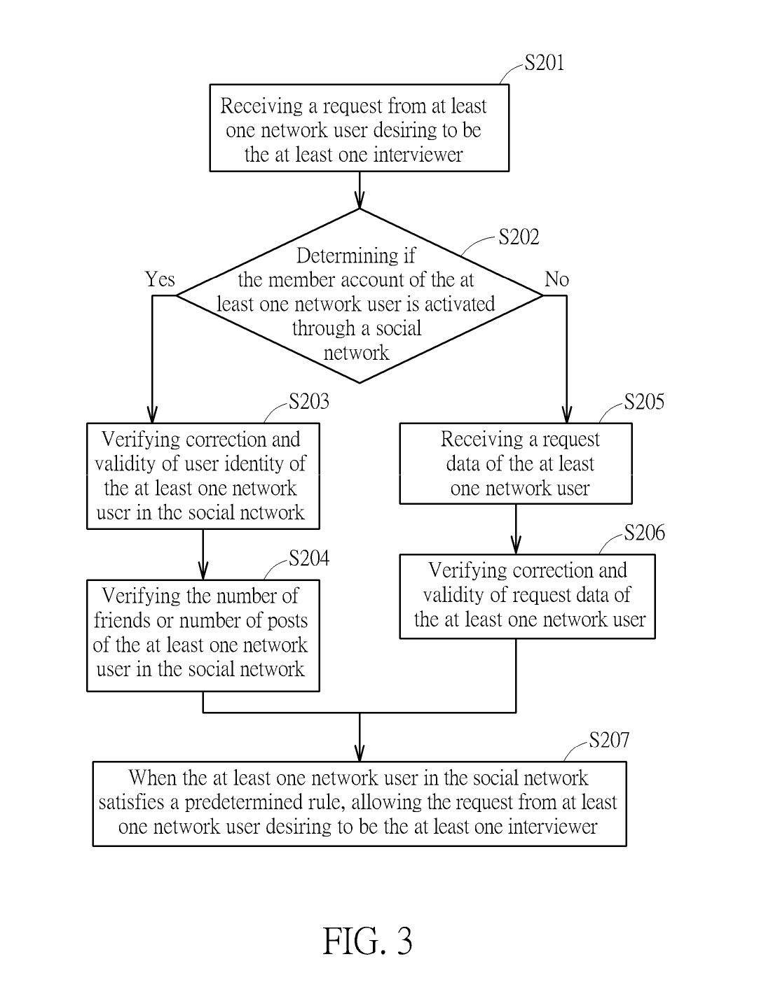

FIG. 3 illustrates the flowchart of at least one network user desired to be at least one interviewer according to the present invention. As shown in FIG. 3, the method of network user desired to be the interviewer includes two sub-processes. The first sub-process includes step S201, step S202, step S203, step S204, and step S207, as follows.
step S201: receiving a request from at least one network user desiring to be the at least one interviewer;
step S202: determining if the member account of the at least one network user is activated through a social network;
step S203: verifying correction and validity of user identity of the at least one network user in the social network;
step S204: verifying the number of friends or number of posts of the at least one network user in the social network; and
step S207: when the at least one network user in the social network satisfies a predetermined rule, allowing the request from at least one network user desiring to be the at least one interviewer.

In the first sub-process, the network user desiring to be the interviewer has to send a request to network interview system 100. In step S201, the network interview system 100 receives the request from at least one network user desiring to be the at least one interviewer. The network interview system 100 then determines if the member account of the at least one network user is activated through a social network in step S202. If the member account is activated through a social network, the network interview system 100 verifies correction and validity of user identity of the at least one network user in the social network in step S203. Specifically, user identity verification can avoid some adverse accounts such as an advertising account or virus account. When the user identity of the at least one network user is successfully verified, the network interview system 100 further verifies the number of friends or the number of posts of the at least one network user in the social network. Particularly, verifying number of friends or number of posts in the social network can avoid some inactive accounts. After the user identity is successfully verified (or satisfies a predetermined check rules) through step S203 and step S204, the network interview system 100 allows the request from at least one network user desiring to be the at least one interviewer. In addition, to ensure the authenticity of the user account, the network interview system 100 can further verify a correction and validity by sending a short message to the smart phone of applicants. If the smart phone verification is success, the allowance of being the interviewer is approved by the network interview system 100.

The second sub-process includes step S201, step S202, step S205, step S206, and step S207, as follows.
step S201: receiving a request from at least one network user desiring to be the at least one interviewer;
step S202: determining if the member account of the at least one network user is activated through a social network;
step S205: receiving a request data of the at least one network user;
step S206: verifying correction and validity of request data of the at least one network user; and
step S207: when the at least one network user in the social network satisfies a predetermined rule, allowing the request from at least one network user desiring to be the at least one interviewer.

In the second sub-process, the network user desired to be the interviewer has to send a request to network interview system 100. In step S201, the network interview system 100 receives the request from at least one network user desiring to be the at least one interviewer. The network interview system 100 then determines if the member account of the at least one network user is activated through social network in step S202. If the member account is activated without using a social network, the network interview system 100 receives a request data of the at least one network user in step S205. Then, the network interview system 100 verifies correction and validity of request data of at least one network user in step S206. After the request data is successfully verified (or satisfies a predetermined check rules) through step S205 and step S206, the network interview system 100 allows the request from the at least one network user desiring to be the at least one interviewer. In addition, to ensure the authenticity of the user account, the network interview system 100 can further verify a correction and validity by sending a short message to the smart phone of applicants. If the smart phone verification is successful, the allowance of being the interviewer is approved by the network interview system 100. For example, the network user has the experience of being a reporter. When the network user desires to be the interviewer, the network user can show a press card. Then, the network interview system 100 verifies the correction and validity of press card. The press card is regarded as supporting information to facilitate the election of interviewer by the questioner.

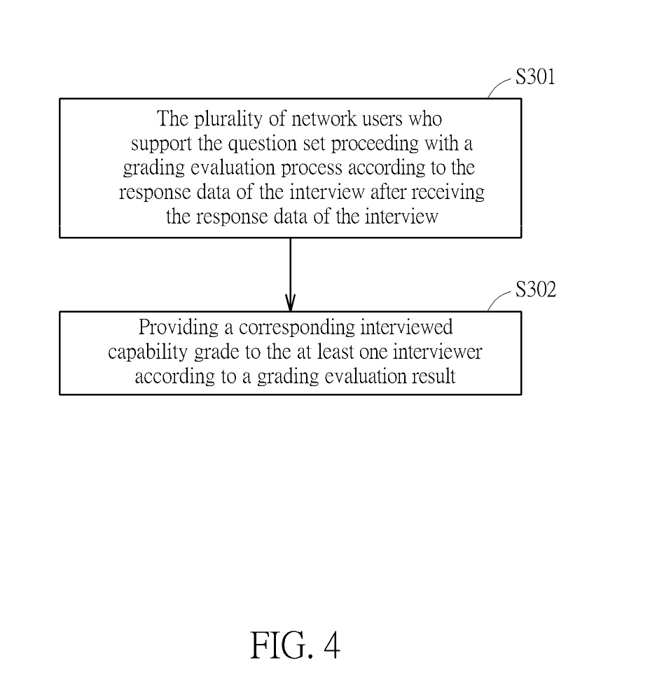

FIG. 4 illustrates the flow chart of a grading evaluation process according to an embodiment of the present invention. After the at least one interviewer transmits a response data of the interview to the network according to step S106 in FIG. 2, the network users proceed with a grading evaluation process with respect to the interview. The grading evaluation process includes the following steps.
step S301: the plurality of network users who support the question set proceeding with a grading evaluation process according to the response data of the interview after receiving the response data of the interview; and
step S302: providing a corresponding interviewed capability grade to the at least one interviewer according to a grading evaluation result.

After the at least one interviewer transmits a response data of the interview to the network, all network users can receive the data of the interview. However, in step S301, the network interview system 100 provides at least one grading evaluation mechanism which is only being operated by the plurality of network users who support the question set. In other words, the plurality of network users who support the question set proceeds with the grading evaluation process according to the response data of the interview after receiving the response data of the interview. Specifically, the limitation in step S301 is used (i.e., only users who support the question set) to maintain the fairness and objectivity of grading evaluation process. For example, if the grading evaluation process can be operated by all network users, some network users who oppose the question set may disturb the evaluation result by grading a very low score, while losing objectivity of the grading evaluation process. As a result, although the interview is satisfactory, it still has a risk to get low average score. To solve this problem, the limitation in step S301 is introduced to avoid the opposition which is argued by the antagonistic network users. By doing so, the result of the grading evaluation process can indicate the capability of interviewer or performance of interview with high objectivity. Although the network users who support the question set proceed to the grading evaluation process in the embodiment, the present invention is not limited thereto. For example, the grading evaluation process can be operated by all network users (i.e., including supported users and opposing users) in order to analyze the impacted degree of the interviewed result for all network users in other embodiments. In this case, the network interview system 100 can perform in-depth analysis and may provide an accurate score with respect to the capability of interviewer or performance of interview. In the following step S302, the network interview system 100 provides a corresponding interviewed capability grade (score) to the at least one interviewer according to a grading evaluation result. Such score affects the qualification calculation in step S104 for selecting at least one qualified interviewer to conduct the interview. For example, the status of the question set is changed to one which can be used in an interview and the questioner constraints the qualification of interviewer capability by a lower bound score equal to 5. By doing so, the network interview system 100 gives interviewers having score greater than the right to conduct the interview in step S104. Thus, the flexibility and reliability of interview can be improved by the grading evaluation process. For another example, the questioner constraints the qualification of interviewer capability by a lower bound score equal to 0. By doing so, the network interview system 100 gives interviewers having score greater than 0 the right to conduct the interview in step S104. Besides, the grading score of interviewed capability can be further categorized to various professional fields. For example, each interviewer has five types of scores corresponding to five professional fields. The questioner can choose the interviewer according to a specific score type corresponding to a specific professional field. By applying various types of scores corresponding to various professional fields, the reliability of interviewed quality can be further improved.

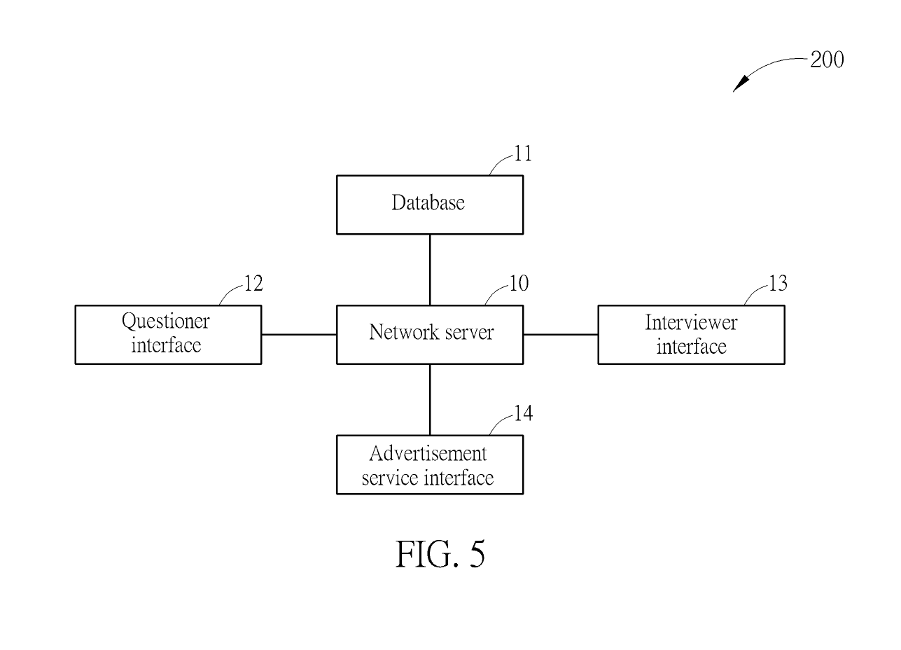

FIG. 5 is a block diagram of another network interview system 200 according to an embodiment of the present invention. As shown in FIG. 5, the structure of network interview system 200 is similar to the structure of network interview system 100. The difference is that the network interview system 200 includes an advertisement service interface 14 coupled to a network server 10. The function of advertisement service interface 14 is expressed below. After the at least one interviewer transmits a response data of the interview to the network interview system 200 according to the step S106 in FIG. 2, the network server 10 receives the response data of interview and enables the advertisement service interface 14 to activate a count of number of views. In the embodiment, the number of views is defined as the value of any data measurement, such as click through rate or value of popularity. Then, the network interview system 200 gives the profit to at least one interviewer and/or questioner according to the number of views counted by the advertisement service interface 14. The steps of profit allocation are illustrated below.

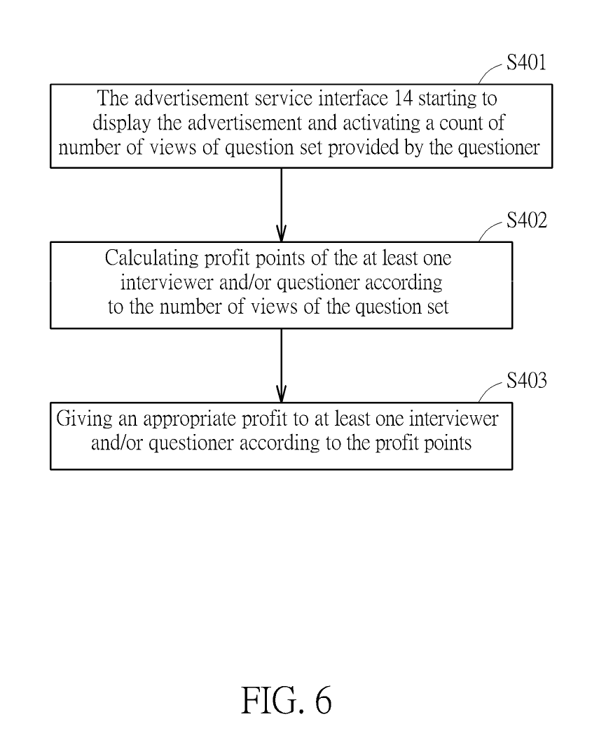

FIG. 6 illustrates the flow chart of profit allocation in FIG. 5 according to an embodiment of the present invention. As shown in FIG. 6, step S401 to step S403 are introduced to achieve the profit allocation. The detailed illustration of step S401 to step S403 can be written as follows.
step S401: the advertisement service interface 14 starting to display the advertisement and activating a count of number of views of question set provided by the questioner;
step S402: calculating profit points of the at least one interviewer and/or questioner according to the number of views of the question set; and
step S403: giving an appropriate profit to at least one interviewer and/or questioner according to the profit points.

In step S401, after the at least one interviewer transmits a response data of the interview to the network according to the step S106 in FIG. 2, the advertisement service interface 14 starts to display the advertisement and activates a count of number of views of the question set provided by the questioner. Then, the network interview system 200 calculates profit points of at least one interviewer and/or questioner according to the number of views of the question set provided by the advertisement service interface 14. In the embodiment, the calculation of profit points is not limited by using a specific equation or function. For example, the network interview system 200 may give one profit point to the at least one interviewer and/or questioner when the majority of network users satisfy the quality of interview. After the profit points of the at least one interviewer and/or questioner are calculated, the network interview system 200 gives an appropriate profit to at least one interviewer and/or questioner according to the profit points in step S403. Thus, the total profit produced by the advertisement service interface 14 is allocated to the at least one interviewer and/or questioner by step S401 to step S403. By doing so, the at least one interviewer and/or questioner can get appropriate reward.

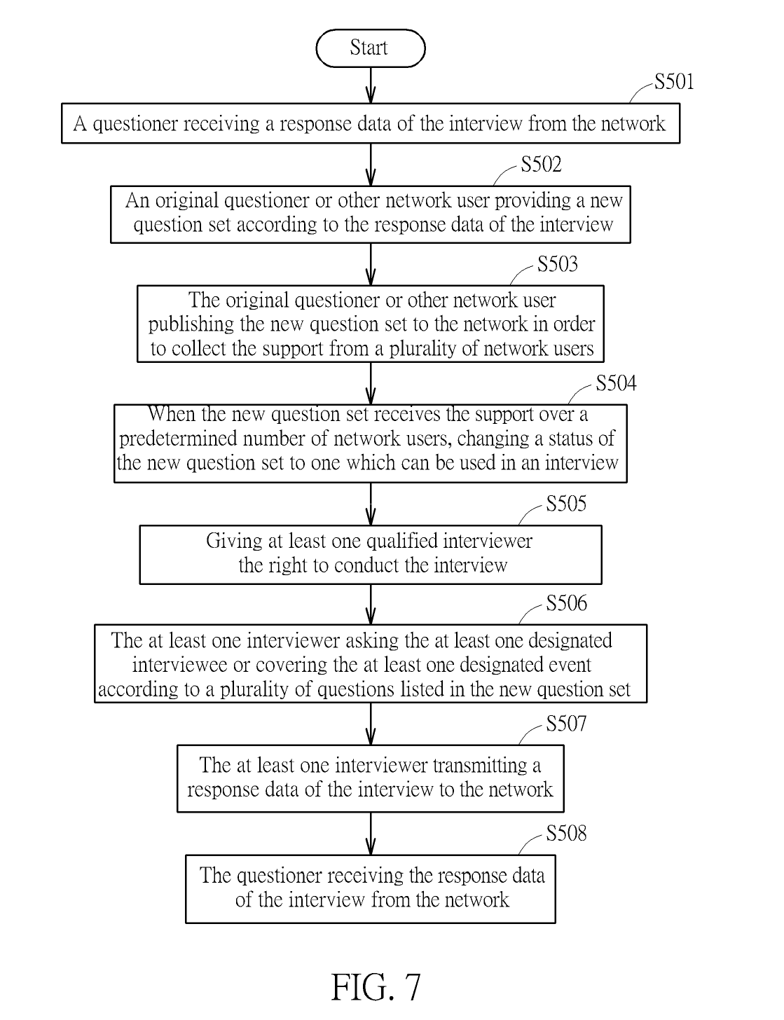

To make an in-depth interview with a specific topic of discussion, a method of continuous discussion with a specific topic is introduced in the network interview. FIG. 7 illustrates the flow chart of another network interview method (i.e., continuous discussion with a specific topic) according to an embodiment of the present invention. In FIG. 7, the network interview method includes 8 steps, as step S501 to step S508, as
step S501: a questioner receiving a response data of the interview from the network;
step S502: an original questioner or other network user providing a new question set according to the response data of the interview;
step S503: the original questioner or other network user publishing the new question set to the network in order to collect the support from a plurality of network users;
step S504: when the new question set receives the support over a predetermined number of network users, changing a status of the new question set to one which can be used in an interview;
step S505: giving at least one qualified interviewer the right to conduct the interview;
step S506: the at least one interviewer asking the at least one designated interviewee or covering the at least one designated event according to a plurality of questions listed in the new question set;
step S507: the at least one interviewer transmitting a response data of the interview to the network; and
step S508: the questioner receiving the response data of the interview from the network.

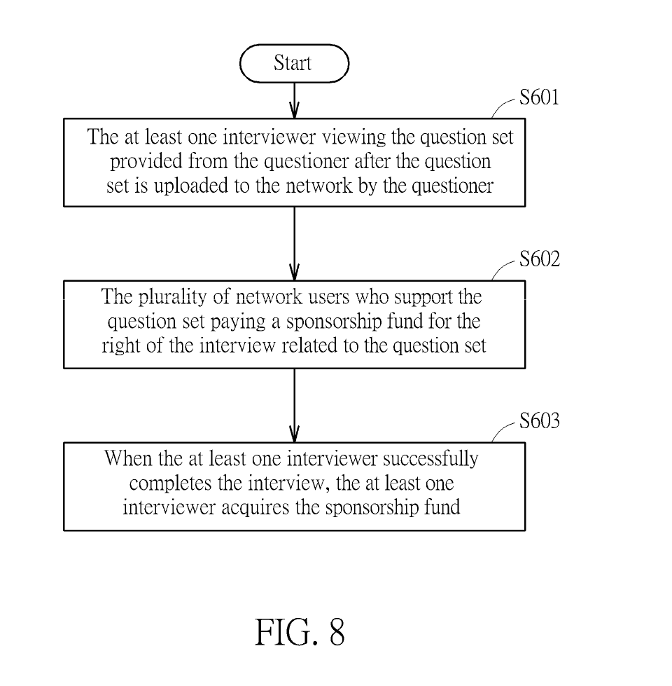

In the embodiment, the function of step S501 can be regarded as the function of step S107 in FIG. 2. The functions of step S502 to step S508 can be regarded as the functions of subsequent steps of S107 in FIG. 2. In the embodiment in FIG. 2, the questioner provides the question set. The interviewer asks the interviewee according to the question set. Finally, the questioner receives the response data of the interview. However, if the original questioner or other network user still has some questions, the original questioner or other network user provides a new question set according to the response data of the interview in step S502. Similarly, in the embodiment, the new question set associates to at least one designated interviewee and/or at least one designated event. The following step S503 to step S508 are similar to step S102 to step S107. Thus, they are omitted here. Unlike the conventional network interview with one-time discussion of a specific topic, a continuous discussion of a specific topic is introduced in the embodiment of FIG. 7. By continuously republishing the new question set by the original questioner or other network user, the reliability, accuracy, professionalism, and fluency can be improved. Specifically, the method of continuous discussion with a specific topic is not limited by using step S501 to step S508. The method can be performed by a repeated step loop. For example, after performing step S508, the network interview system goes back to perform step S501 until no new question set is being provided. To further increase the reliability and popularity of network interview, some additional steps are introduced to the embodiment of the present invention. FIG. 8 illustrates the flow chart of a method for improving the reliability of the interview according to an embodiment of the present invention. As shown in FIG. 8, 3 steps are introduced for improving the reliability of the interview, as follows.
step S601: the at least one interviewer viewing the question set provided from the questioner after the question set is uploaded to the network by the questioner;
step S602: the plurality of network users who support the question set paying a sponsorship fund for the right of the interview related to the question set; and
step S603: when the at least one interviewer successfully completes the interview, the at least one interviewer acquires the sponsorship fund.

In step S601 to step S603, network users of the network interview system can freely pay the sponsorship fund for the right of the interview related to the question set. Thus, with the accumulation of the sponsorship fund, at least one professional interviewer is attracted to the interview. Further, the more the sponsorship fund is accumulated, the more resources of interview can be used. By doing so, the reliability of the interview can be further improved.

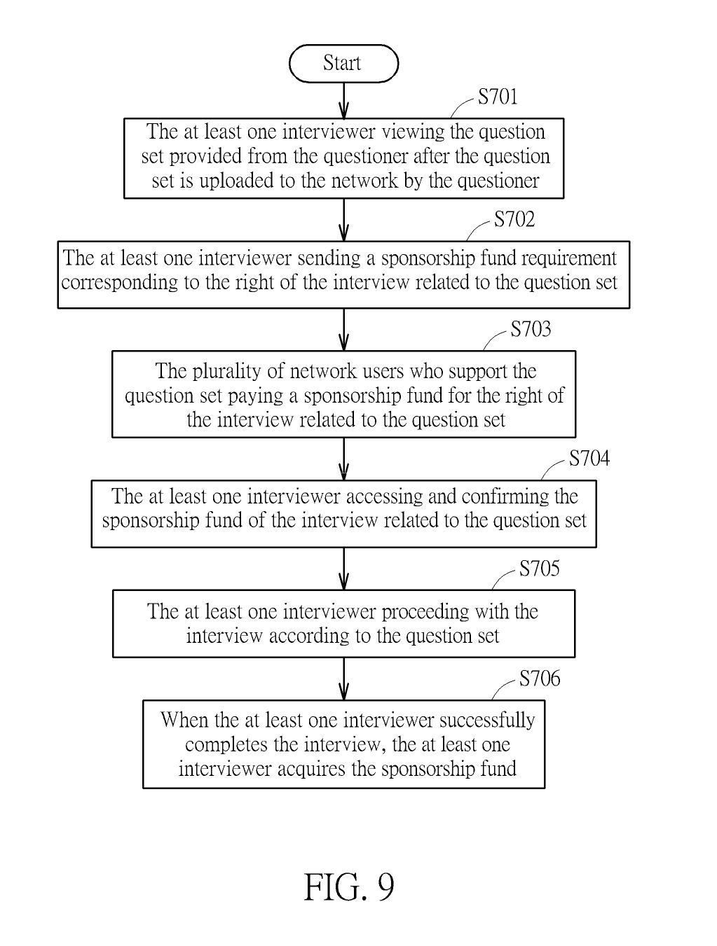

FIG. 9 illustrates the flow chart of another method for improving the reliability of the interview according to the present invention. As shown in FIG. 9, 6 steps are introduced for improving the reliability of the interview, as follows.
step S701: the at least one interviewer viewing the question set provided from the questioner after the question set is uploaded to the network by the questioner;
step S702: the at least one interviewer sending a sponsorship fund requirement corresponding to the right of the interview related to the question set;
step S703: the plurality of network users who support the question set paying a sponsorship fund for the right of the interview related to the question set;
step S704: the at least one interviewer accessing and confirming the sponsorship fund of the interview related to the question set;
step S705: the at least one interviewer proceeding with the interview according to the question set; and
step S706: when the at least one interviewer successfully completes the interview, the at least one interviewer acquires the sponsorship fund.

In step S701, the at least one interviewer views the question set provided from the questioner. Specifically, step S701 can be performed after step S102 in FIG. 2. In other words, after the question set is uploaded to the network by the questioner (i.e., step S102), the at least one interviewer views the question set provided from the questioner (i.e., step S701). The interview may require numerous resources to be performed according to the question set. For example, the questioner wants to know the ecology of polar bears and provides the associated question set. The at least one interviewer sends the sponsorship fund requirement corresponding to the right of the interview related to the question set in step S702. Particularly, many interviewers may apply for the right of the interview related to the question set. The interview costs calculated by different interviewer are also different. Thus, every interviewer desiring to get the right of the interview can request the interview cost in forms of the sponsorship fund requirement. In step S703, the plurality of network users who support the question set pay the sponsorship fund for the right of the interview related to the question set. Then, the at least one interviewer accesses and confirms the sponsorship fund of the interview related to the question set in step S704. Specifically, when the sponsorship fund reaches the interview cost calculated by the interviewer, the interview can be started. The at least one interviewer (i.e., who has enough sponsorship fund) proceeds with the interview according to the question set in step S705. On the contrary, when the sponsorship fund does not reach to the interview cost calculated by the interviewer, the interviewer can still proceed with the interview or can transfer the right of the interview to another interviewer which proceeds with the interview with lower interview cost. When the at least one interviewer successfully completes the interview, the at least one interviewer acquires the sponsorship fund in step S706. By doing so, the success rate for forming and proceeding with the interview can be increased. If the interviewer is professional and has a good reputation, the sponsorship fund of the interview would be increased so that the quality and reliability of interview can be further improved.

To sum up, the present invention illustrates a network interview system and interview method. The idea is to use the operation of questioner publishing the question set to a network. By collecting the support from a plurality of network users, the question set has a chance to apply to the network interview. Instead of an election process used to choose a question set in the conventional network interview system, the method of network interview in the present invention can avoid the disturbance caused by some network users who oppose the arguments of the question set. Further, a grading evaluation process, a continuous discussion method, and a sponsorship fund mechanism can also be used with the network interview. As a result, the present invention conducts an in-depth network interview in conjunction with high reliability, accuracy, professionalism, and fluency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of performing a network interview comprising:
a questioner providing a question set associating to at least one designated interviewee and/or at least one designated event;
the questioner publishing the question set to a network in order to collect the support from a plurality of network users;
when the question set receives the support over a predetermined number of network users, changing a status of the question set to one which can be used in an interview;
giving at least one qualified interviewer the right to conduct the interview;
the at least one interviewer asking the at least one designated interviewee or covering the at least one designated event according to a plurality of questions listed in the question set;
the at least one interviewer transmitting a response data of the interview to the network; and
the questioner receiving the response data of the interview from the network.

2. The method of claim 1, wherein the at least one interviewer transmitting the responses of the interview to the network, is that the at least one interviewer transmitting the responses of the interview to the network after passing a user authentication process.

3. The method of claim 1, further comprising:
the plurality of network users who support the question set proceeding with a grading evaluation process according to the response data of the interview after receiving the response data of the interview; and
providing a corresponding interviewed capability grade to the at least one interviewer according to a grading evaluation result.

4. The method of claim 1, wherein giving the at least one qualified interviewer the right to conduct the interview, is giving at least one interviewer satisfying a predetermined interviewed capability grade the right to conduct the interview.

5. The method of claim 1, further comprising:
the plurality of network users viewing the question set provided from the questioner after the question set being uploaded to the network by the questioner;
the plurality of network users who support the question set paying a sponsorship fund to the right of the interview related to the question set; and
when the at least one interviewer successfully completing the interview, the at least one interviewer acquiring the sponsorship fund.

6. The method of claim 1, further comprising:
the at least one interviewer viewing the question set provided from the questioner after the question set being uploaded to the network by the questioner;
the at least one interviewer sending a sponsorship fund requirement corresponding to the right of the interview related to the question set;
the plurality of network users who support the question set paying a sponsorship fund to the right of the interview related to the question set; and
when the at least one interviewer successfully completing the interview, the at least one interviewer acquiring the sponsorship fund.

7. The method of claim 1, further comprising:
receiving a request from at least one network user desired to be the at least one interviewer.

8. The method of claim 7, wherein receiving a request from at least one network user desired to be the at least one interviewer comprises :
when the at least one network user sends a request by using a social network, verifying a correction and validity of user identity of the at least one network user in the social network; and
when the correction and validity of user identity of the at least one network user in the social network satisfies a predetermined rule, allowing the request from at least one network user desired to be the at least one interviewer.

9. The method of claim 7, wherein receiving a request from at least one network user desired to be the at least one interviewer comprises:
when the at least one network user sends the request without using a social network, verifying a request data of the at least one network user; and
when the request data satisfies a predetermined qualification, allowing the request from at least one network user desired to be the at least one interviewer.

10. The method of claim 7, wherein receiving a request from at least one network user desired to be the at least one interviewer comprises:
when the at least one network user sends the request without using a social network, verifying a request data of the at least one network user;
verifying a correction of user identity of the at least one network user; and
when the request data satisfies a predetermined qualification and the user identity is verified, allowing the request from at least one network user desired to be the at least one interviewer.

11. The method of claim 1, further comprising:
when the questioner transmits the question set to a network, activating a count of number of views by an advertisement service interface.

12. The method of claim 11, further comprising:
calculating profit points of the questioner according to the number of views of the question set.

13. The method of claim 11, further comprising:
calculating profit points of the at least one interviewer according to the number of views of the question set.

14. A network interview system comprising:
a questioner interface for transmitting a question set associating to at least one designated interviewee and/or at least one designated event provided from a questioner;
an interviewer interface for transmitting data of at least one interviewer;
a database for saving data; and
a network server connected to the questioner interface, the interviewer interface, and the database;
wherein the questioner provides the question set to the network server through the questioner interface, the network server saves the question set to the database and publishes the question set to a network in order to collect the support from a plurality of network users, when the question set receives the support over a predetermined number of network users, the network server changes the status of the question set to one which can be used in an interview, at least one qualified interviewer is given the right to conduct the interview, the at least one interviewer asks the at least one designated interviewee or covering the at least one designated event according to a plurality of questions listed in the question set, the at least one interviewer transmits a response data of the interview to the network server, the network server saves the response data of the interview to the database, and the network server transmits the response data of the interview to the questioner through the questioner interface.
